(19) United States
(12) Patent Application Publication
(10) Pub. No.: US 2024/0211358 A1
(43) Pub. Date: Jun. 27, 2024

(54) SYSTEM MANAGEMENT APPARATUS, SYSTEM MANAGEMENT METHOD, AND SYSTEM MANAGEMENT PROGRAM

(71) Applicant: Hitachi, Ltd., Tokyo (JP)

(72) Inventor: Jun NAKAJIMA, Tokyo (JP)

(21) Appl. No.: 18/237,502

(22) Filed: Aug. 24, 2023

(30) Foreign Application Priority Data
Dec. 22, 2022 (JP) 2022-205899

(51) Int. Cl. G06F 11/20; G06F 11/14; G06Q 30/0283; H04L 67/1097

(52) U.S. Cl. CPC G06F 11/2094; G06F 11/1451; G06Q 30/0283; H04L 67/1097

(57) ABSTRACT

A hybrid cloud system includes a management server, a storage of a source-side data center serving as a remote copy source, and a storage by a cloud service provided from a target-side data center serving as a backup destination. The management server is configured to make a request for a disaster recovery configuration using the storage by the cloud service, based on a recovery time objective requirement related to a recovery time objective, a recovery point objective requirement related to a recovery point objective, and a recovery level objective requirement related to a recovery level objective.

### CROSS-REFERENCE TO RELATED APPLICATION

The present application claims priority from Japanese application JP2022-205899, filed on Dec. 22, 2022, the content of which is hereby incorporated by reference into this application.

### BACKGROUND OF THE INVENTION

### 1. Field of the Invention

The present invention relates to a system management apparatus, a system management method, and a system management program.

### 2. Description of Related Art

There are many risks such as natural disasters or terrors of resulting in stops of business systems or data losses, and thus it is important to realize nonstop operations or data protections in business systems. As one of systems realizing nonstop operations or data protection, there is a disaster recovery (hereinafter abbreviated to a “DR”). The DR is a structure and system that recovers business when a disaster occurs in a customer data center due to a natural disaster, a terror, or the like, and a business system in the data center is stopped.

In the DR, a remote copy technology is adopted to protect data and enable business to resume even in a case where a storage device itself is lost due to a large-scale disaster. The remote copy technology is a technology for providing storage devices at two distant sites and duplicating data between the storage devices. The remote copy technology is broadly classified into three technologies.

One technology is a storage replication technology for storing a write request in a copy source storage device directly receiving the write request and also storing the write request in a copy destination storage device positioned at a remote location when the copy source storage device receives the write request from a host computer. The storage replication technology includes a storage synchronous replication in which a write completion notification is transmitted to a host computer transmitting the write request after writing of data is completed in the copy source storage device and the copy destination storage device positioned at a remote location, and a storage asynchronous replication in which the write completion notification is transmitted to the host computer transmitting the write request without awaiting completion of writing of data in the copy destination storage device when writing of data in the copy source storage device is completed.

Another technology is a backup technology for reading data of the copy source storage device in response to the read request to the copy source storage device and writing data in the copy destination storage device in response to the write request to the copy destination storage device so that the data is also stored in the copy destination storage device positioned at a remote location. This technology is implemented by a backup program operating on any computer, and many types of software dedicated to backup has also been widespread.

Still another technology is a cloud data backup service for transmitting the data of the copy source storage device to a storage device provided by a copy destination cloud by using a service provided by a cloud vendor. This technology is implemented by using a virtual appliance provided by a cloud vendor as a gateway for connection to the copy destination storage device, as the copy source storage device.

In recent years, forms of cloud DRs (a DR using a cloud) in which business continues on clouds using a remote copy technology in disasters occurring in the customer data center, have been widespread. This is because it is not necessary to prepare data centers and hardware for operating business systems in disasters for DRs by myself and the DRs can be constructed at smaller instruction costs.

In the DRs between customer data centers of the related art, data centers are provided in advance, devices such as storages are introduced to prepare resources, and configurations of the DRs are designed and constructed in accordance with user requirements. In the cloud DRs as well, predetermined resources can be prepared in advance as in the DRs between customer data centers, and DR configurations can be designed and constructed in accordance with the user requirements. However, cloud advantages of building diverse configurations quickly and flexibly are insufficient. When resources for the DRs are prepared in advance on clouds, costs are taken more than necessary. However, it is difficult to estimate how much costs are spent in use of public clouds, and costs more than expected are taken in many cases.

JP4598817B discloses a system and a method for determining a DR configuration (a line bandwidth) within a range in which a recovery point objective (RPO) is satisfied in asynchronous replication.

In general, three requirements that are a recovery time objective (RTO), the RPO, and a recovery level objective (RLO) become important as DR requirements. However, in JP4598817B, the RTO and the RLO that are important requirements of the DRs other than the RPO are not added.

Only a specific function, specifically, only a DR configuration using asynchronous storage replication, is taken into consideration. Among diverse configurations that can be taken in the cloud DRs, an appropriate DR configuration based on the DR requirements (the RTO, the RPO, and the RLO) cannot be determined.

### SUMMARY OF THE INVENTION

The invention has been devised to solve the foregoing problems. That is, an object of the invention is to provide a system management apparatus, a system management method, and a system management program capable of deriving an appropriate DR configuration based on the RTO, the RPO, and the RLO in a DR using a cloud.

To solve the foregoing problems, according to an aspect of the invention, a system management apparatus includes an information processing device configured to manage a system including a storage of a specific data center and a storage by a cloud service provided from another data center. The information processing device is configured to request, from the system, a disaster recovery configuration using the storage by the cloud service satisfying a recovery time objective requirement, a recovery point objective requirement, and a recovery level objective requirement, based on the recovery time objective requirement related to a recovery time objective, the recovery point objective requirement related to a recovery point objective, and the recovery level objective requirement related to a recovery level objective.

According to another aspect of the invention, there is provided a system management method using an information processing device configured to manage a system including a storage of a specific data center and a storage by a cloud service provided from another data center other than the specific data center. The information processing device is configured to request, from the system, a disaster recovery configuration using the storage by the cloud service satisfying a recovery time objective requirement, a recovery point objective requirement, and a recovery level objective requirement, based on the recovery time objective requirement related to a recovery time objective, the recovery point objective requirement related to a recovery point objective, and the recovery level objective requirement related to a recovery level objective.

According to still another aspect of the invention, a system management program causes a computer to execute a process for managing a system including a storage of a specific data center and a storage by a cloud service provided from another data center other than the specific data center. The computer is caused to execute the process of requesting, from the system, a disaster recovery configuration using the storage by the cloud service satisfying a recovery time objective requirement, a recovery point objective requirement, and a recovery level objective requirement, based on the recovery time objective requirement related to a recovery time objective, the recovery point objective requirement related to a recovery point objective, and the recovery level objective requirement related to a recovery level objective.

According to the invention, it is possible to derive an appropriate DR configuration based on the RTO, the RPO, and the RLO in a DR using a cloud.

### BRIEF DESCRIPTION OF THE DRAWINGS

FIG. 1 is a block diagram illustrating a system configuration example of a hybrid cloud system;

FIG. 2 is a block diagram illustrating a hardware configuration example of a computer;

FIG. 3 is a diagram illustrating an example of a performance capacity history table;

FIG. 4 is a diagram illustrating an example of a requirement management table;

FIG. 5 is a diagram illustrating an example of a cloud service management table;

FIG. 6 is a diagram illustrating an example of a hybrid cloud configuration management table;

FIG. 7 is a diagram illustrating an example of a transition time management table;

FIG. 8 is a flowchart illustrating a procedure example of a cloud DR configuration derivation process;

FIG. 9 is a flowchart illustrating a procedure example of a transition time estimation process;

FIG. 10 is a diagram illustrating an example of a cloud DR configuration input screen;

FIG. 11 is a diagram illustrating an example of a cloud DR configuration presentation screen; and

FIG. 12 is a flowchart illustrating a cloud DR configuration derivation processing procedure.

### DESCRIPTION OF EMBODIMENTS

Hereinafter, embodiments of the invention will be described with reference to the drawings. Throughout all the drawings of the embodiments, the same or corresponding portions are denoted by the same reference numerals.

The embodiments to be described below do not limit the invention within the claims and it cannot be said that all elements described in the embodiments and all combinations thereof are not essential for solutions of the invention. In the drawings, the same reference numerals in a plurality of drawings denote the same elements.

In the following description, information of the invention will be described in expressions of “aaa table” or the like, but the information may be expressed in data structures other than the data structure such as a table. Therefore, to imply independency from the data structure, “aaa table” or the like is referred to as “aaa information” in some cases. Further, when content of each piece of information is described, expressions such as “identification information”, “identifiers”, “names”, and “IDs” are used, but can also be replaced with each other.

In the following description, “programs” will be described as subjects in some cases. However, since processes determined by causing processors to execute programs are executed while using memories and communication ports (communication devices, management I/Fs, or data I/Fs), the processors may be subjects in description.

A process disclosed with a program as a subject may be a process performed by a computer such as a management server (management computer) or an information processing device. Various programs may be installed in computers by storage media which can be read by program distribution servers or computers. Various programs may be executed in a hypervisor or container type of virtual environment.

### First Embodiment

### System Configuration Example of Hybrid Cloud System

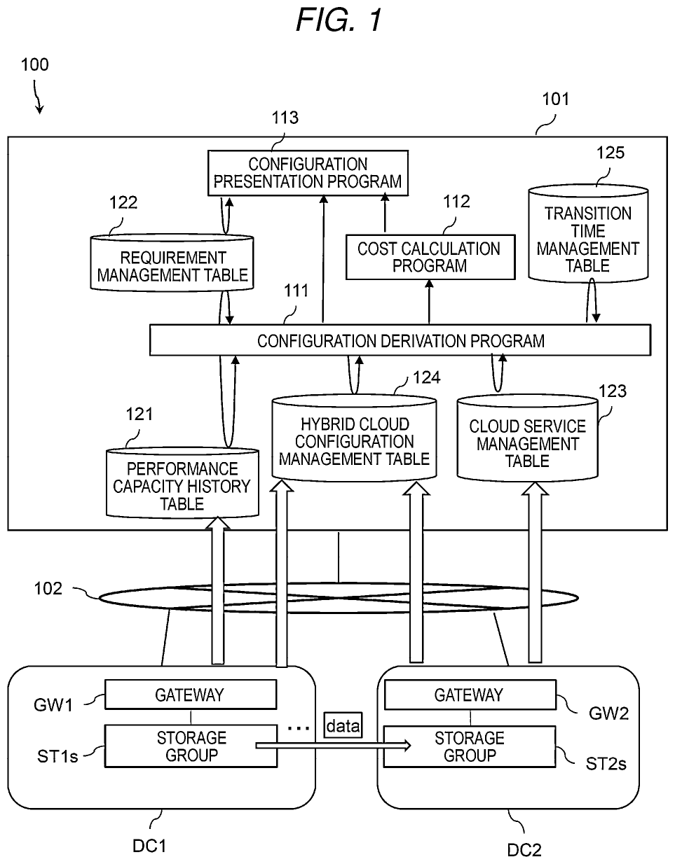

A system management apparatus (management server 101) according to a first embodiment of the invention will be described. FIG. 1 is a block diagram illustrating a system configuration example of a hybrid cloud system 100 including the system management apparatus (the management server 101) according to the first embodiment. The hybrid cloud system 100 includes the management server 101, a source-side data center DC1 serving as a remote copy source, and a target-side data center DC2 serving as a backup destination (DC1 and DC2 are simply referred to as “DC” when the DC1 and the DC2 are not particularly distinguished from each other).

Here, a DC configuration in which a mainly customer-owned data center (on-premises/private cloud type DC) is the source-side DC serving as the remote copy source and a data center provided as a public cloud by a cloud vendor (public cloud type DC) is the target-side DC serving as the backup destination will be described. However, any source-side or target-side data center may be the on-premises/private cloud type DC or the public cloud type DC, and the invention is not limited thereto. The public cloud type data centers are often divided for each location where the data center exists such as a region or an availability zone or for each unit (failures do not spread) that is independent of system operation. In this case, these data centers are assumed to be handled as different data centers for each combination including the region or the availability zone. In consideration of failures assumed in DRs, the source-side DC and the target-side DC are assumed to be different data centers.

The management server 101 and the data center DC are communicably connected to each other via a network 102 such as the Internet, a local area network (LAN), or a wide area network (WAN). The hybrid cloud system 100 is a cloud system capable of constructing a configuration (hereinafter referred to as use configuration) for connecting data centers DC (on-premises public clouds) to each other so that one side can use a service of the other side.

The management server 101 includes a configuration derivation program 111, a cost calculation program 112, and a configuration presentation program 113. The configuration derivation program 111 is a program that derives a cloud DR configuration (disaster recovery configuration) based on DR requirements determined by a user input or the like. The cost calculation program 112 is a program that calculates a cloud cost taken to hold the cloud DR configuration derived by the configuration derivation program 111. The configuration presentation program 113 is a program that presents a satisfactory situation of the DR requirements together with cost information requested by the cost calculation program 112 for the cloud DR configuration derived by the configuration derivation program 111.

The management server 101 includes a performance capacity history table 121, a requirement management table 122, a cloud service management table 123, a hybrid cloud configuration management table 124, and a transition time management table 125.

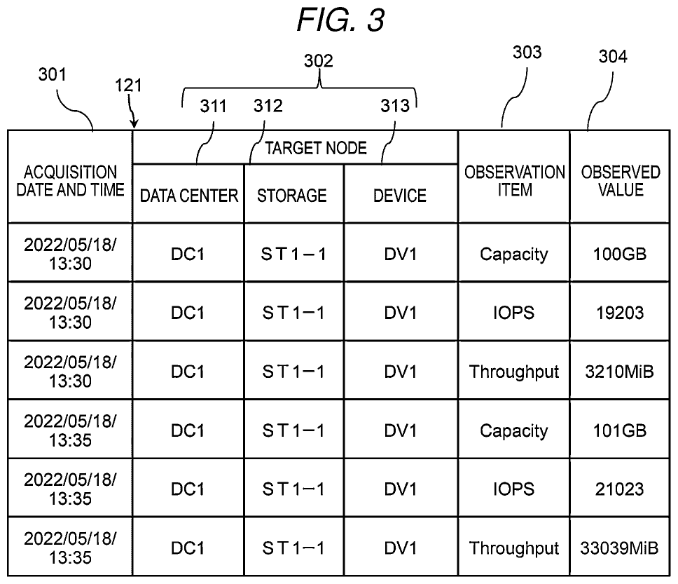

The performance capacity history table 121 is a table in which history information of performance of the data center DC and a capacity of a storage ST in the data center DC are held. The details will be described below in FIG. 3.

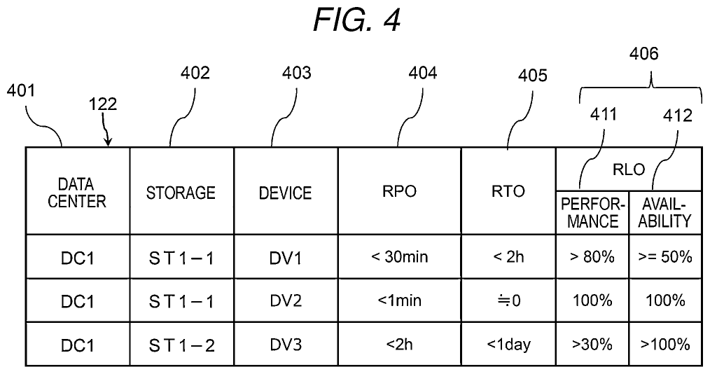

The requirement management table 122 is a table in which the DR requirements designated by the user input or the like, specifically, information regarding a recovery time objective (RTO), a recovery point objective (RPO), and a recovery level objective (RLO), are held in data storage area units of a copy source DC (DC1). The details will be described below in FIG. 4.

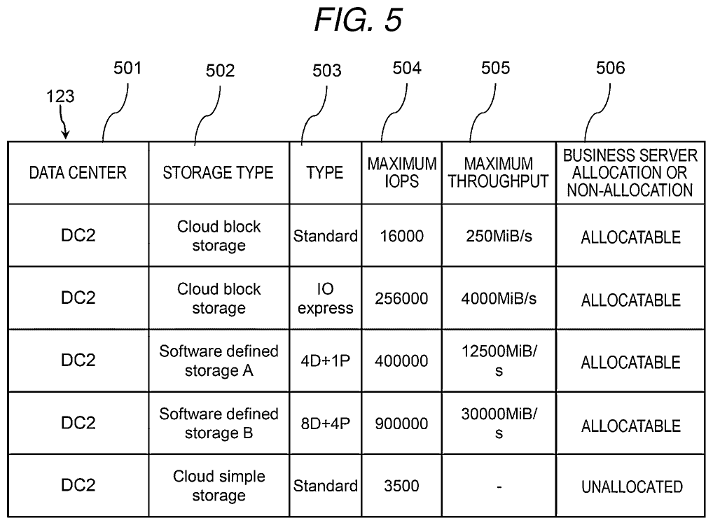

The cloud service management table 123 is a table in which information regarding cloud services provided by the DC is held. The details will be described below in FIG. 5.

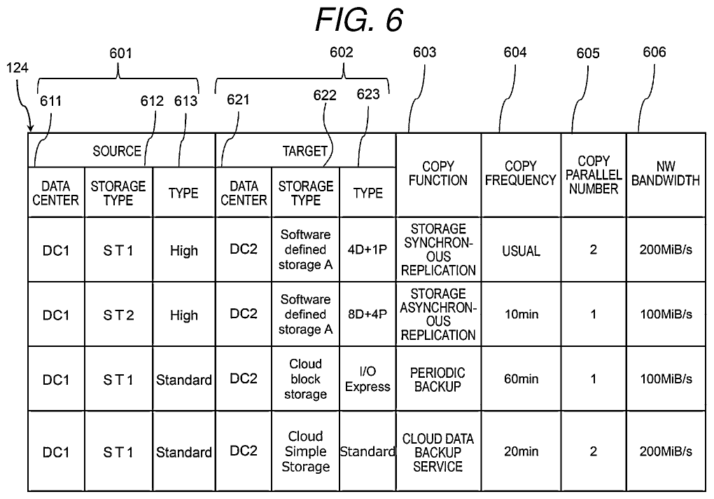

The hybrid cloud configuration management table 124 is a table in which information regarding a connection configuration between the DCs is held. The details will be described below in FIG. 6.

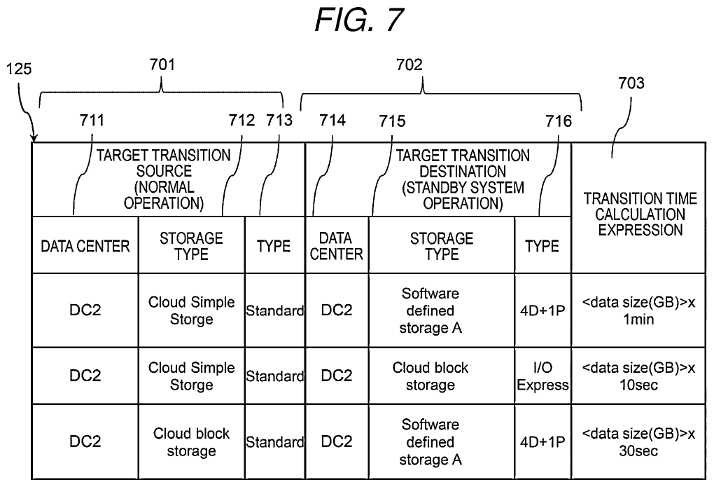

The transition time management table 125 is a table in which information regarding data storage areas serving as a transition source and a transition destination, and a transition time calculation expression for calculating a time taken for data transition from the transition source to the transition destination are held. The details will be described below in FIG. 7.

The source-side data center DC1 (for example, an on-premises type) serving as the remote copy source includes a gateway GW1 and a storage group STIs. A storage in the storage group STIs is referred to as a storage ST1. When there are a plurality of storages ST1, a branch number is given to the end.

The target-side data center DC2 (for example, a public cloud type) serving as the backup destination includes a gateway GW2 and a storage group ST2s. A storage in the storage group ST2s is referred to as a storage ST2. When there are a plurality of storages ST2, a branch number is given to the end.

When the gateways GW1 and GW2 are not distinguished from each other, the gateways GW1 and GW2 are referred to as a gateway GW. When the storage groups ST1s and ST2s are not distinguished from each other, the storage groups ST1s and ST2s are referred to as a storage group STs. A storage in the storage group STs is referred to as a storage ST. Hardware Configuration Example of Computer (Management Server 101, Data Center DC)

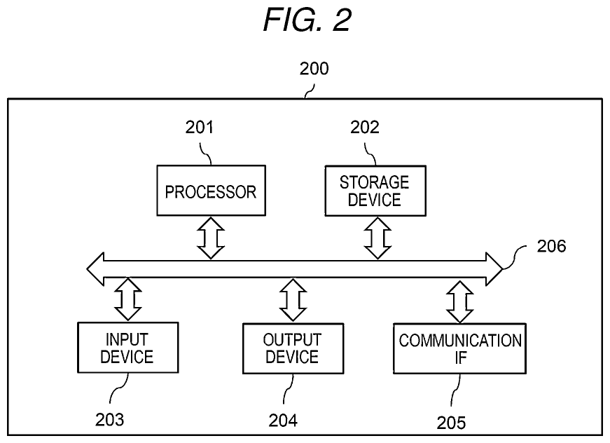

FIG. 2 is a block diagram illustrating a hardware configuration example of a computer 200. The computer 200 includes a processor 201, a storage device 202, an input device 203, an output device 204, and a communication interface (communication IF) 205. The processor 201, the storage device 202, the input device 203, the output device 204, and the communication IF 205 are connected to each other via a bus 206. The computer 200 may also be referred to as an “information processing device” or a “server”.

The processor 201 controls the computer 200. The storage device 202 is a working area of the processor 201. The storage device 202 is a non-transitory or a temporary recording medium that stores various types of programs or data. Examples of the storage device 202 include a read only memory (ROM), a random access memory (RAM), a hard disk drive (HDD), and a flash memory. The input device 203 inputs data. Examples of the input device 203 include a keyboard, a mouse, a touch panel, a ten key, a scanner, a microphone, and a sensor. The output device 204 outputs data. Examples of the output device 204 include a display (display device), a printer, and a speaker. The communication IF 205 is connected to the network 102 to transmit and receive data.

The computer 200 is applied to the management server 200 and the data center DC. The number of computers 200 to be applied may be plural. The data center DC includes, for example, physical resources such as the computer 200, a storage device, a network device, and the like.

Specifically, the configuration derivation program 111, the cost calculation program 112, and the configuration presentation program 113 are, for example, functions implemented by causing the processor 201 to execute programs stored in the storage device 202. Specifically, the performance capacity history table 121, the requirement management table 122, the cloud service management table 123, the hybrid cloud configuration management table 124, and the transition time management table 125 are implemented by data tables stored in the storage device 202, for example. Configuration Example of Table

FIG. 3 is a diagram illustrating an example of the performance capacity history table 121. The performance capacity history table 121 has an acquisition date and time 301, a target node 302, an observation item 303, and an observed value 304, as fields.

The acquisition date and time 301 is a date and time at which the target node 302 of that entry acquires the observed value 304 of the observation item 303. The target node 302 is identification information for specifying an observation source of the observed value 304. The target node 302 has a data center 311, a storage 312, and a device 313, as subfields. The data center 311 is the data center DC of the target node 302 or identification information for specifying the data center DC. The storage 312 is the storage St in the storage group STs in the data center DC of the target node 302 or identification information for specifying the storage ST. The device 313 is a device DV of the storage 312 of the target node 302 or identification information for specifying the device DV.

The observation item 303 is an item of the observed value 304 observed from the device 313, that is, a performance index. In the observation times 303, for example, there are a capacity of the device 313 and the number of I/Os per unit time (second) (IOPS). The observed value 304 is a value observed for the observation item 303. As the observation item 303, a performance item other than the performance item mentioned here or another item, for example, redundancy for each storage or availability for each device, may be included, and the invention is not limited thereto.

FIG. 4 is a diagram illustrating an example of the requirement management table 122. The requirement management table 122 has a data center 401, a storage 402, a device 403, an RPO 404, an RTO 405, and an RLO 406, as fields. In the requirement management table 122, information regarding an RPO requirement related to the RPO (also referred to as a “recovery point objective requirement”), an RTO requirement related to the RTO (also referred to as a “recovery time objective requirement”), and an RLO requirement related to the RLO (also referred to as a “recovery level objective requirement”) is stored.

The data center 401 is identification information for specifying the data center DC. The storage 402 is identification information for specifying the device DV of the storage 402. The device 403 is identification information for specifying the storage ST in the storage group STs in the data center 401. The RPO 404 is a value of the RPO designated by the user input or the like. Here, the RPO indicates a target recovery time point from a failure, and is an index that indicates at what time point in the past data recovery can be made. In the case of “<30 min” shown in the first row of FIG. 4, it indicates that the user requires data recovery at a time point within past 30 minutes can be made. The RTO 405 is a value of the RTO designated by the user input or the like. Here, the RTO indicates a target recovery time, and is an index indicating a time taken to recover the system. In the case of “<2h” shown in the first row of FIG. 4, is indicates that a user requires a recovery within 2 hours. The RLO 406 has a performance 411 and an availability 412, as subfields. Here, the RLO indicates a target recovery level and is an index indicating how much percentage the system is recovered when a state at a normal operation time is 100%. In the case of performance of “>80%” and availability of “>=50%” shown in the first row of FIG. 4, performance of 80% or more and availability of 50% or more of a normal operation in the copy source are required even when the system is operating in the copy destination in a disaster. Here, the availability of 50% indicates that when redundancy of the system in the copy source is 4, redundancy in the copy destination is 2 in a disaster, that is, double redundancy is sufficient.

FIG. 5 is a diagram illustrating an example of the cloud service management table 123. The cloud service management table 123 has a data center 501, a storage type 502, a type 503, a maximum IOPS 504, a maximum throughput 505, and a business server allocation or non-allocation 506, as fields. Here, it is assumed that a cloud service stored in the cloud service management table 123 can be used, for example, when free use registration is executed or a paid contract procedure is made on a homepage of a cloud service vendor.

The data center 501 is identification information for specifying the data center DC. In the data center 501, in addition to or instead of the identification information, information for specifying information regarding a cloud service data center for providing a cloud service, for example, information indicating a type of a cloud service vendor and a provision region, may be stored. In this case, specifically, for example, information for specifying information regarding a cloud service data center providing a cloud service is “′Data center l′ indicates ‘Tokyo data center of a cloud service vendor A’” or the like. This is because a type or content of a cloud service differs depending on a region of a vendor-owned data center.

The storage type 502 indicates a storage type in a storage e service provided by a cloud service vendor. Specifically, “Cloud block storage” indicating provision of a block storage service, “Cloud simple storage” indicating provision of a file storing service, “Software defined storage A” indicating a software-based storage provided by a storage vendor, and the like are stored. The type 503 is stored for each different viewpoint of a user requirement such as performance or availability as a type which can be selected in a service indicated by the storage type 502 and provided by the data center 501. In the maximum IOPS 504 and the maximum throughput 505, values defined in services of a maximum IOPS and a maximum throughput which can be taken in types of services indicated by the storage type 502 and the type 503 and provided by the data center 501 are stored, respectively. The business server allocation or non-allocation 506 stores whether a data storage area provided as the storage type 502 can be allocated to a business server providing a business service.

Here, the values of the type 503 and the maximum IOPS 504 are values on a catalog specification publicized by a cloud service vendor. Information other than the items mentioned here may be information that influences a user requirement, such as information regarding another performance, information regarding availability or failure resistance, information regarding data protection such as presence or absence of encryption or presence or absence of automatic backup, a security policy, or the like, and the invention is not limited thereto.

As illustrated in FIG. 5, for example, in the case of a type of a storage type “Cloud block storage”, examples in which high performance “IO Express” and a standard “Standard” are provided as services in which the maximum IOPS and the maximum throughput are different, and in the case of a type of a storage type “Software defined storage A”, an example in which “4D+1P” indicating failure resistance of 4D+1P is provided.

FIG. 6 is a diagram illustrating an example of the hybrid cloud configuration management table 124. The hybrid cloud configuration management table 124 has a source 601, a target 602, a copy function 603, a copy frequency 604, a copy parallel number 605, and an NW bandwidth 606, as fields. The source 601 is information for specifying a data transmission source and has a data center 611, a storage type 612, and a type 613, as subfields. The data center 611 is identification information for specifying a data center DC of the data transmission source or the data center DC.

The target 602 is information for specifying a data transmission destination and has a data center 621, a storage type 622, and a type 623, as subfields. The data center 621 is identification information for specifying a data center DC of the data transmission destination or the data center DC. Here, information regarding the data centers 611 and 621 is the same as the identification information stored in the data center 401 of FIG. 4 and the data center 501 of FIG. 5. In the storage types 612 and 622, information regarding a model of a storage provided by a storage vendor or information regarding a storage service provided by a cloud service vendor is stored. Here, information regarding the storage types 612 and 622 is the same as information regarding a storage type included in the information stored in the storage 402 of FIG. 4 and information stored in the storage type 502 of FIG. 5.

In the types 613 and 623, information indicating different types of specifications which can be selected based on requirements such as performance or availability in a storage type provided by a storage vendor is stored, or information indicating different types of viewpoints regarding user requirements such as performance and availability, which can be selected in the storage type and are provided by a cloud service vendor, is stored.

Here, information regarding the types 613 and 623 is the same as information which can uniquely be specified from the information stored in the storage 402 of FIG. 4 and the information stored in the type 503 of FIG. 5.

The copy function 603 indicates a copy function, as described in Description of Related Art, which can be used when data is copied from the source 601 of the data transmission source to the target 602 of the data transmission destination. Specifically, “Storage synchronous replication” and “Storage asynchronous replication” indicate that data can be transferred between the source 601 and the target 602 using synchronous and asynchronous direct copy functions, respectively, between the storages provided by a storage vendor. “Periodic Backup” indicates that backup can be executed from the source 601 to the target 602 via another management computer. “Cloud data backup service” is stored as a value indicating that a cloud data backup service for transmitting data of the source 601 to the target 602 can be used by using a service provided by a cloud vendor.

The copy frequency 604 indicates a data transmission frequency of the copy function 603 and the copy parallel number 605 indicates the number of data transfer that can be executed in parallel. The NW bandwidth 606 indicates an NW bandwidth between the source 61 and the target 602. Here, the copy parallel number 605 and the NW bandwidth 606 are illustrated as items that influence a data transmission speed, but the invention is not limited thereto and other items may be stored.

FIG. 7 is a diagram illustrating an example of the transition time management table 125. The transition time management table 125 is a table indicating a method for calculating a time taken for data transition in a standby system of the cloud DR, and has a target transition source 701, a target transition destination 702, and a transition time calculation expression 703, as fields.

The target transition source 701 is information indicating a configuration operating as a standby system at a normal operation time when an original site is not affected by a disaster, and has a data center 711, a storage type 712, and a type 713, as subfields. The data center 711 is identification information for specifying a data center DC operating as a standby system at a normal time. The storage type 712 is identification information for specifying a storage type in the data center 711. In the type 713, information indicating different types of specifications which can be selected based on performance or availability in the storage type 712 of the data center 711 is stored, or information indicating different types of viewpoints regarding user requirements such as performance and availability, which can be selected in the storage type, is stored.

The target transition destination 702 is information indicating a configuration operating as a standby system after the original site is affected by a disaster, and has a data center 714, a storage type 715, and a type 716, as subfields. Values set in the fields are similar to those of the data center 711, the storage type 712, and the type 713. The transition time calculation expression 703 is information indicating a calculation expression for calculating a time taken for data transition from the transition source 701 to the transition destination 702. For example, in the first row of the transition time management table 125 illustrated in FIG. 7, a time of “<data size (GB)>×1 min” is taken for data transition from “DC2-Cloud Simple Storage (Standard)” to “DC2-Software defined storage A (4D+1P)”. When a size of data to be transitioned is 100 GB, it can be understood that 100 GB×1 min=100 min are taken for data transition. Here, it is assumed that the transition time calculation expression 703 is determined and preset for each configuration of the transition source and the transition destination. The example illustrated here in which only the size of the data is a variable is an example. For example, a calculation expression including performance, the numbers, or the like of CPUs, memories, and network ports of the transition source and the transition destination as variables, or a fixed calculation expression including no variables may be used, and the invention is not limited thereto. The calculation expression may be set to be fixed from a catalog specification value or the calculation expression itself may be corrected in accordance with an actual environment. For example, based on a result of the data transition, the calculation expression may be changed from “<data size (GB)>×1 min” to “<data size (GB)>×2 min”.

### Cloud DR Configuration Derivation Process

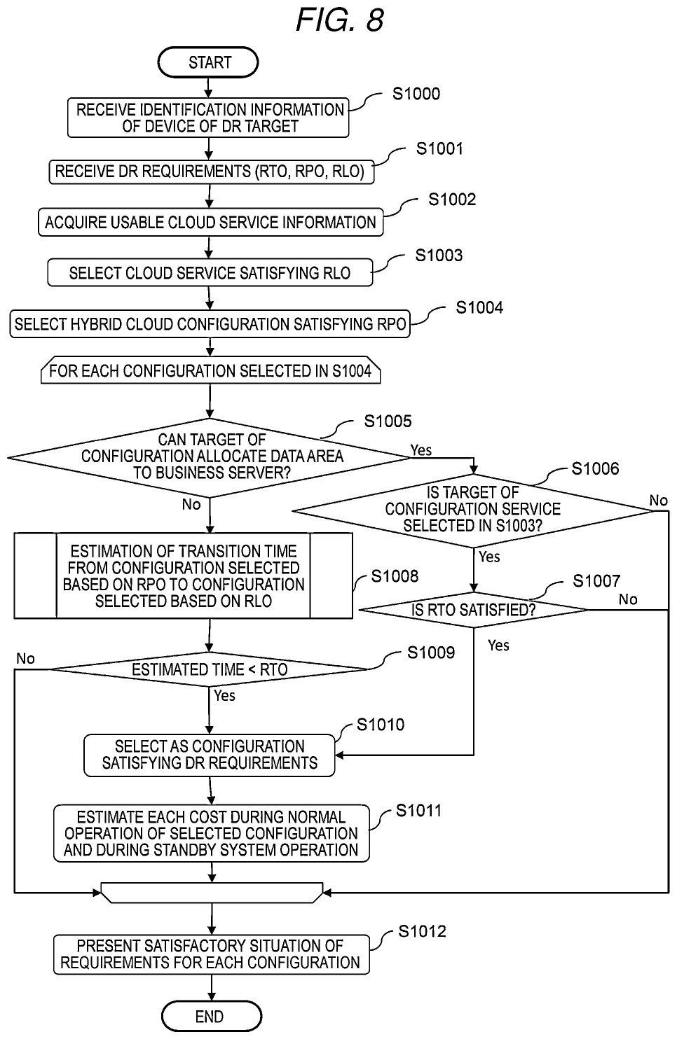

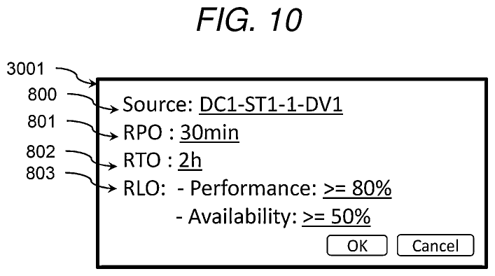

FIG. 8 is a flowchart illustrating a procedure example of a cloud DR configuration derivation process. The configuration derivation program 111 receives identification information of a device of a DR target (step S1000). Here, a user inputs identification information of the device on an input screen or the like illustrated in FIG. 10. Subsequently, information regarding the RTO, the RPO, and the RLO is received as the DR requirements of the user input (step S1001). The user may preset the DR requirements the target device and store the DR requirements in the requirement management table 122 (which is not illustrated), and the configuration derivation program 111 may acquire and use the information regarding the DR requirements from the requirement management table in this step.

Here, a specific example of the DR requirements shown in a cloud DR configuration input screen 3001 of FIG. 10 will be described. “RPO: 30 min” indicates that the user requirements contain a return to data up to 30 minutes before, and the user requirements do not contain a recovery of data close to a present time than 30 minutes before, for example, a recovery of data 10 minutes before. “RTO: 2 h” indicates that the user requirements contain the fact that a time until the data can be used from a business host is within 2 hours. “RLO: Performance: >=80%” indicates that the user requirements contain the fact that system performance to be recovered after being affected by a disaster is 80% or more of the system performance before being affected by a disaster. Here, as a system performance requirement, any item or value such as the IOPS, a throughput, or CPU performance may be designated and may be evaluated from a combination of a plurality of indexes, for example. The invention is not limited thereto. “RLO: Availability: >=50%” indicates that the user requirements contain the fact that the availability of the system to be recovered after being affected by a disaster is 50% or more of the availability of the system before being affected by a disaster. Here, as a system availability requirement, any item or value such as whether ports are configured to be single, multiple, or triple, whether a parity configuration of RAID of discs is RAID0, RAID5 (3D+1P), RAID6 (4D+2P), whether the system is constructed throughout a plurality of environments in which cloud services are physically separated, or whether the system is configured throughout sites of cloud services may be designated, or may be evaluated from a combination of a plurality of indexes. The invention is not limited thereto.

Subsequently, the configuration derivation program 111 acquires information regarding usable cloud service from the cloud service management table 123 (step S1002). Here, the information regarding usable cloud service is information regarding a cloud service which can be used by a user accessing the management server 101. It is assumed that the information regarding the cloud service is registered in advance in the cloud service management table 123.

Subsequently, the configuration derivation program 111 obtains an average of observation values for a latest fixed period of time of an observation item such as the IOPS or a throughput from the performance capacity history table 121, and obtains a value satisfying the RLO acquired in step S1001. Here, any value may be taken as the fixed period of time and the invention is not limited thereto.

For example, when an average of observation values for the latest 1 hour of the IOPS is “400000” and the RLO acquired in step S1001 is “Performance>80%”, a value satisfying the RLO is “IOPS>320000”.

Then, a cloud service (a configuration of a standby system operation) satisfying the RLO acquired in step S1001 is derived (selected) from the cloud service acquired in step S1002 (step S1003).

In the case of the specific example taken in this step, types other than two types of “Data center: DC2”−“Storage type: Software defined storage A” and “Data center DC2”-“Storage type: Software defined storage B” as shown in the cloud service management table 123 of FIG. 5 cannot satisfy “IOPS>320000”. Therefore, the two types of configurations are derived.

Subsequently, the configuration derivation program 111 derives a configuration (a configuration of a normal operation) satisfying the RPO acquired in step S1001 with reference to the information of the hybrid cloud configuration management table 124 of FIG. 6 (step S1004). For example, when the RPO acquired in step S1001 is “<30 min”, a copy frequency is “usual”, “10 min”, and “20 min” in the first, second, and fourth rows of the hybrid cloud configuration management table 124 illustrated in FIG. 6, which are configurations satisfying the RPO, but a copy frequency is “60 min” in the third row, which is a configuration not satisfying the RPO. In this step, three configurations are selected. Here, in the example, the example in which it is determined whether the RPO is satisfied with reference to only the copy frequency 604 is described. However, even when a copy operation is executed once at intervals of 30 minutes, a time is taken until end of the copy operation depending on a parallel number of the copy operation or a congested state of the NW, and thus access to only data 40 minutes before can be made. Therefore, it may be determined whether the RPO is satisfied with reference to items including items such as the copy parallel number 605 and the NW bandwidth 606 that influence a data transmission speed, other than the copy frequency 604, and any method may be used.

Subsequently, the configuration derivation program 111 executes the processes from subsequent steps S1005 to S1011 on each configuration selected in step S1004 until the processes are executed on all the configurations selected in step S1004. After the processes are executed on all the configurations selected in step S1004, the configuration derivation program 111 moves to step S1012.

First, with reference to the information regarding the target 602 of the configuration selected in step S1004, the information regarding the configuration shown in the target 602 is acquired from the cloud service management table 123 of FIG. 5 and it is determined whether a data area is allocated to the business server (step S1005). When the data can be allocated to the business server, the process moves to step S1006. When the data cannot be allocated, the process moves to step S1008 to execute the process of step S1008. For example, information regarding the data center “DC2”, the storage type “Software defined storage A”, and the type “4D+1P”, which are indicated by the target 602 in the first row in FIG. 6 is retrieved in the cloud service management table 123 of FIG. 5 to acquire information in the corresponding third row. The information regarding the business server allocation or non-allocation 506 is “allocatable” as a result of the acquired information. Therefore, in this case, it is determined that the business server is allocatable and the process moves to step S1006.

In step S1006, it is determined whether the configuration selected in step S1004 and satisfying the RPO is the configuration in which the service selected in step S1003 is used and which satisfies the RLO (step S1006). When the service does not satisfy the RLO as a result of the determination of step S1006, it is determined that the configuration does not satisfy the requirement and the process moves to a process of a subsequent configuration. When the service satisfies the RLO, the process moves to step S1007.

In step S1007, it is determined whether the configuration selected in step S1004 and satisfying the RPO and the RLO satisfies the RTO requirement. Here, the configuration determined in step S1007 is a configuration in which a data area can be allocated to the business server, that is, the device is in a prepared state. Therefore, it is assumed that the RTO becomes substantially zero. However, for example, a time until the server can be allocated for each configuration may be managed or may be used for the determination process here. The invention is not limited thereto. When it is determined in step S1007 that the RTO is satisfied, the process moves to step S1010. When it is determined that the RTO is not satisfied, the process moves to a process of a subsequent configuration.

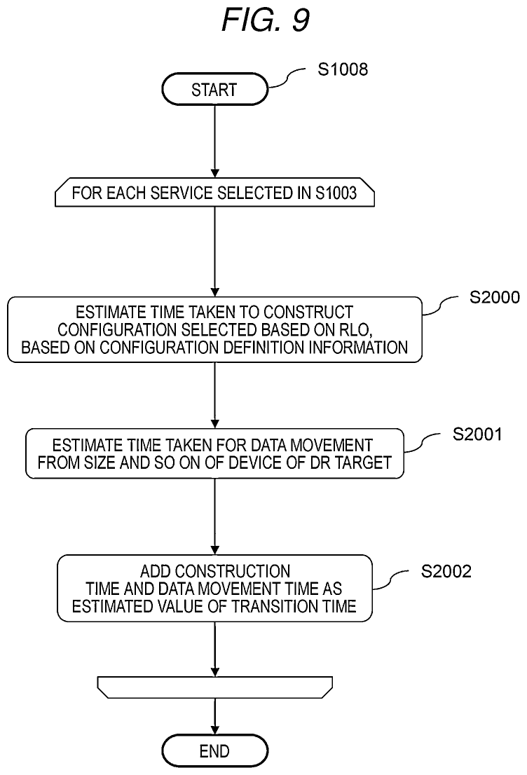

In step S1008, a transition time from the configuration selected based on the RPO to the configuration selected based on the RLO is estimated with reference to the information of the transition time management table 125. The details will be described in a transition time estimation process of FIG. 9. Subsequently, the estimated time is compared with the information regarding the RTO acquired in step S1001. In the case of the “estimated time<RTO” (step S1009), the configuration (the configuration selected based on the RLO satisfying the estimated time<RTO and the configuration selected based on the RPO) is selected as a configuration satisfying the DR requirements (step S1010). When the “estimated time<RTO” is not satisfied, the process moves to a process of a subsequent configuration.

Then, the cost calculation program 112 estimates a cost of the configuration selected in step S1010 (step S1011) and the process moves to a process of a subsequent configuration. Here, in the cost estimation process, a cost can be estimated based on a service use fee and a use capacity defined for each “data center”/“storage type”/“type” illustrated in FIG. 5. For example, a cost of a device of a DR destination can be estimated by acquiring a service use fee in GB units of “DC2”/“Cloud block storage”/“Standard” from a site of a cloud service vendor, acquiring a capacity of the device of the DR target from the performance capacity history table 121 of FIG. 3, and multiplying the service use fee in GB units by the capacity of the device of the DR target. Here, a calculation method of obtaining an average of observation values for a latest fixed period of time of an observation item as a capacity of the device of the DR target or using a latest observation value can be taken, but the invention is not limited thereto.

Subsequently, the configuration presentation program 113 presents a satisfactory situation of the requirements together with the cost obtained by the cost calculation program 112 for each configuration selected by the configuration derivation program 111 in step S1011 (step S1012).

### Transition Time Estimation Process

FIG. 9 is a flowchart illustrating a procedure example of a transition time estimation process indicating details of step S1008 illustrated in FIG. 8. When the hybrid cloud configuration selected in step S1004 is each configuration in which a target of the configuration cannot be allocated to the business server, this process is executed.

First, for each service selected in step S1003, a time taken to construct the target configuration of the hybrid management configuration shown in the hybrid cloud configuration management table 124 is estimated (step S2000). For example, a time taken to construct “DC2-Software defined storage A (4D+1P)” which is the configuration of the target in the first row of the hybrid cloud configuration management table 124 illustrated in FIG. 6 is estimated.

In the estimation, a method for adding a time taken for deployment to a cloud environment of “Software defined storage A”, a time taken to generate a volume on “Software defined storage A”, or a time taken for setting of a path or login so that the generated volume is seen from the business server can be taken, but a calculation method is not limited thereto. Each of the taken times may be calculated using a value based on the catalog specification or may be calculated using a value obtained from an average value, a maximum value, or the like of the history information. Each time taken for copy setting or NW setting may be added to set a time taken for construction.

Subsequently, a time taken for data movement is estimated from a volume size or the like of the DR target (step S2001). A size of the device of the DR target is obtained when a user designates the device of the DR target or information regarding a capacity is acquired from the performance capacity history table 121 of FIG. 3. Here, a calculation method of obtaining an average of observation values for a latest fixed period of time of an observation item as a capacity of the device of the DR target or using a latest observation values can be taken, but the invention is not limited thereto.

Here, the hybrid cloud configuration satisfying the RPO selected in step S1004 is set in the transition source 701 of the transition time management table 125, the information regarding the cloud service satisfying the RLO selected in step S1003 selects the information set in the transition destination 702 of the transition time management table 125 from the transition time management table 125, the transition time calculation expression 703 of a corresponding combination is acquired from FIG. 7, and a value is substituted into the calculation expression to execute the estimation.

For example, when the configurations selected in steps S1004 and 1003 are configurations from “DC2-Cloud Simple Storage (Standard)” to “DC2-Software defined storage A (4D+1P)” in the first row of the transition time management table 125 of FIG. 7, the transition time calculation expression 703 of data movement time taken for data transition from the transition source to the transition destination is “<data size (GB)>×1 min”. When the size of the volume of the DR target is 120 GB, this can be applied to obtain the time of 120 GB×1 min=2 hours take for data transition. Here, the example in which only the size of the data is used is described as the transition time calculation expression 703 of the data transition, but the invention is not limited thereto. For example, an index such as the number of devices of the DR target or an NW bandwidth such as a port or a switch that influences the data transition may be added to the transition time calculation expression.

Finally, an estimated value of the time taken to construct the configuration acquired in step S2000 and an estimated value of the time taken for the data movement acquired in step S2001 are added to set an estimated value of the transition time (step S2002).

The cloud DR configuration derivation process when the cloud DR configuration is newly constructed is described above with reference to FIGS. 8 and 9. However, the cloud DR configuration constructed once can be re-examined by executing this process periodically or executing this process using a re-examination request or the like from the user as an opportunity. As one specific example in which it is necessary to re-examine the cloud DR, there is a change in a data capacity of the DR target. Specifically, when an amount of data of the DR target increases, an estimated time of the data movement in step S2001 of FIG. 9 is considerably changed. Therefore, it is fully conceivable that the configuration determined to satisfy the RTO requirement in step S1009 of FIG. 8 does not satisfy the RTO with an increase in the amount of data. This can be detected by periodically executing the processes of FIGS. 8 and 9. Therefore, when the selected and constructed DR configuration does not satisfy the requirements, the change in the DR configuration is stimulated, for example, by giving a notification to the user (for example, notifying an external device such as a user terminal of an alert). At this time, a notification may be given to the user in accordance with any method of, for example, presenting a candidate for the DR configuration newly derived in the processes of FIGS. 8 and 9, but the invention is not limited thereto.

As one specific example in which it is necessary to re-examine the cloud DR, there is a change in a cloud service specification related to the DR configuration. When the service specification is changed, content of the cloud service management table 123 of FIG. 5 or the hybrid cloud configuration management table 124 of FIG. 6 is updated. Therefore, it is fully conceivable that the process of deriving a configuration with reference to each table in FIG. 8 is changed, the configuration satisfying the requirements at first does not satisfy the requirements or the better cloud DR configuration is taken. These processes can be detected by executing the processes of FIGS. 8 and 9 periodically. Therefore, when the selected and constructed DR configuration does not satisfy the requirements, the change in the DR configuration is stimulated, for example, by giving a notification to the user. At this time, a notification may be given to the user in accordance with any method of, for example, presenting a candidate for the DR configuration newly derived in the processes of FIGS. 8 and 9, but the invention is not limited thereto.

As one specific example in which it is necessary to re-examine the cloud DR, there is occurrence of a failure in a cloud or an NW related to the DR configuration. In this example, detection of a failure by a known alert monitoring system or performance monitoring system is used as an opportunity when the failure occurs in any component used in the DR configuration. When a configuration including a component where a failure occurs, for example, a port, a CPU, or a switch used by the device used in the DR configuration is used as the DR configuration, the operations of FIGS. 8 and 9 are executed. The configuration management of relationships between these components may be done in accordance with any known method. In this case, by allowing the user to select a configuration in which a component where a failure occurs is not used with reference to failure occurrence information or identifying a configuration in which a component where a failure occurs in the hybrid cloud configuration management table 124 of FIG. 6 is used from the derived results in FIGS. 8 and 9, a configuration including a component where a failure occurs is not derived as an option in the processes of FIGS. 8 and 9, and is selected from the derived configurations.

Even in a case where the DR requirements of the DR configuration once constructed are changed, a DR configuration appropriate for the requirements can be constructed again by executing the processes of FIGS. 8 and 9.

### Cloud DR Configuration Input Screen

FIG. 10 is a diagram illustrating an example of a cloud DR configuration input screen. The cloud DR configuration input screen 3001 is a screen on which a user input is received in steps S1000 and S1001 of FIG. 8. The cloud DR configuration input screen 3001 displays a Source input portion 800 for receiving information regarding a source serving as a DR target, an RPO input portion 801, an RTO input portion 802, and an RLO input portion 803. The example illustrated in FIG. 10 is an example in which the device DV1 of the storage ST1 of the data center DC1 serves as a source, data up to 30 min before occurrence of a failure can be recovered, and a system, here, a device, is enabled to be usable within 2 hours after occurrence of a failure, and the input is executed to retrieve a configuration of a DR destination serving as a target with 80% or more of performance and 50% or more of availability of configuration of a normal system before occurrence of a failure. Here, the RPO, the RTO, the RLO (performance), and RLO (availability), which are the DR requirements, are each input, but it is not necessary to input all of the RPO, the RTO, the RLO (performance), and RLO (availability) and another input related to the DR requirements may be received, for example. For example, as illustrated in FIG. 5, inputting the data center 501 and using a specific cloud vendor may be set as a requirement, inputting the storage type 502 and using a cloud service may be set as requirement, or a cost set as an option which can be confirmed by a user on the result output screen in the first embodiment may be set as a requirement. In this case, filtering is executed in accordance with the requirements in step S1012 of FIG. 8. Instead of the RLO, information based on SLA or SLO, for example, a performance requirement such as the IOPS or a throughput, redundancy 3 (recovery from a failure is possible even in failures in two systems), may be input directly. In this case, such a specific value is used in the process of step S1003 of FIG. 8. A Source which is a known generated device is designated, but only information regarding a location where a device is generated and the DR requirement information may be input, and candidates for the DR destination may be presented when the device is generated. In this case, the device DV1 itself is not designated as a Source, and identification information regarding where the device is generated, such as the storage ST1 of the data center DC1 or the data center DC1, is input. The identification information of the DR target received in step S1000 of FIG. 8 is not an identifier of a known device, but is identification information of a device scheduled to be newly generated here.

### Cloud DR Configuration Presentation Screen

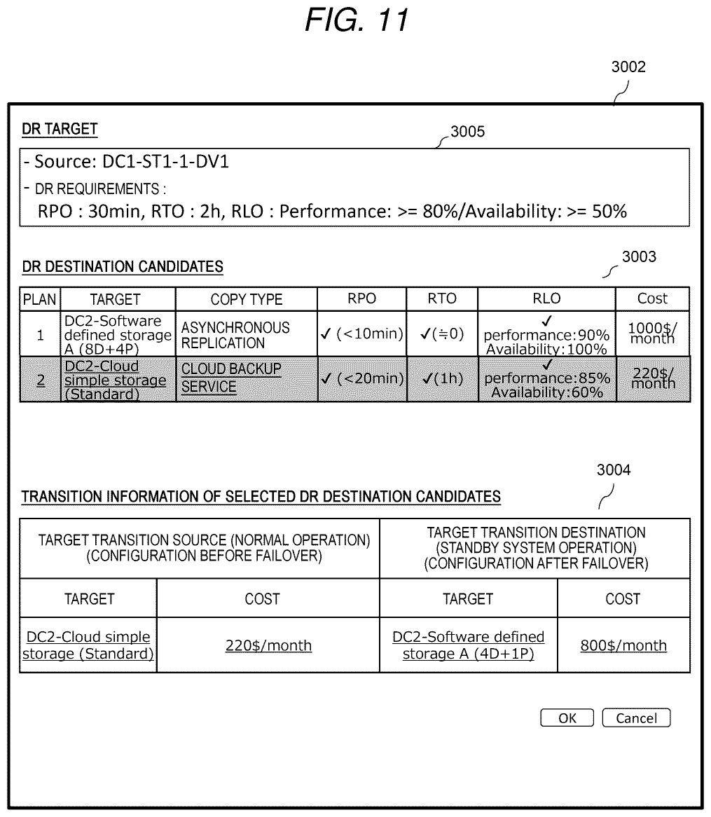

FIG. 11 is a diagram illustrating an example of a cloud DR configuration presentation screen. A cloud DR configuration presentation screen 3002 is a screen displayed in step S1012 of FIG. 8. The cloud DR configuration presentation screen 3002 shows an example in which the DR target selected in FIG. 10 is displayed in a DR target 3005, and a target, a copy type, an RPO satisfactory situation, an RTO satisfactory situation, an RLO satisfactory situation, and a Cost are displayed for each configuration plan serving as a cloud DR destination, as DR destination candidates 3003. The RPO, RTO, and RLO satisfactory situations indicate how much the configuration requirements are satisfied for the DR target shown in the DR target 3005. Specifically, in the case of the first row of the DR destination candidate 3003, it is indicated as an asynchronous replication configuration that the RPO is within 10 minutes and thus satisfies within 30 minutes which is a requirement, the RTO is almost zero and thus satisfies within 2 hours which is a requirement, the performance of the RLO is 90% of the normal system and thus satisfies 80% which is a requirement, and the availability of the RLO is 100% of the normal system and thus satisfies 50% which is a requirement. Here, the example shown in the DR destination candidate 3003 is an example in which there are two configurations satisfying all of the RPO, the RTO, and the RLO which can be compared and examined including a Cost. On the other hand, there is a case where only a configuration which cannot satisfy any requirement is output. In this case, by holding information regarding whether to satisfy each requirement inside without narrowing down the processes in steps S1003 and S1004 of the cloud DR configuration derivation process illustrated in FIG. 8, and by performing the processes after step S1005 and holding information regarding whether to satisfy each requirement inside without narrowing down the processes in steps S1007 and S1009 in the same manner, all the configuration plans can be enumerated including the configurations not satisfying the requirements. At this time, all the configurations may be displayed in the DR destination candidate 3003 or five configurations may be displayed in order from the configurations satisfying more requirements, but the invention is not limited thereto. Here, display of a check mark is used when it is indicated that the requirements are satisfied, but the invention is not limited thereto. When indicating the fact that the requirements are not satisfied, another display such as a hyphen is used to indicate the fact that the requirements are not satisfied.

In transition information 3004 of a selected DR destination candidate, the configuration of the DR destination is displayed in the case of a different configuration between a normal operation time and a standby system operation time, and is displayed as detailed information of a configuration plan when the configuration plan in the DR destination candidate 3003 is selected. Here, a configuration in which the normal system operates before occurrence of a failover due to occurrence of a failure is set as a configuration at the normal operation time, a data center, a storage, a device, and a cost taken to use the configuration are presented, a configuration when the normal system stops after occurrence of a failover due to occurrence of a failure and the DR destination is used is set as a configuration at the standby system operation time, and a data center, a storage, a device, and a cost taken to use the configuration are presented. Here, the example in which a cost at the normal operation time of the transition information 3004 of the selected DR destination candidate is presented is described as a Cost of the DR destination candidate 3003, but the DR destination candidate 3003 may be indicated including a cost at the standby system operation time. By selecting any configuration plan in the DR destination candidate 3003 of the cloud DR configuration presentation screen 3002 and selecting an “OK” button in the bottom right of the screen, the configuration is constructed based on the selected content. The configuration itself may be constructed in accordance with any method, but the invention is not limited thereto.

### Advantages

As described above, the system management apparatus according to the first embodiment of the invention determines whether the RLO is satisfied based on the operation cloud service and the configuration and performance of the storage device of the copy destination, determines whether the RPO is satisfied based on the remote copy technology, the copy parallel number, and the inter-site NW bandwidth, and determines whether the transition time from the normal operation time (the configuration before the failover) to the standby system operation time (the configuration after the failover) satisfies the RTO by using the estimation information. Accordingly, the system management apparatus according to the first embodiment of the invention derives the cloud DR configuration satisfying the requirements of the RTO, the RPO, and the RLO. In addition, the system management apparatus according to the first embodiment of the invention estimates a construction cost of the derived DR configuration, and presents the cost together with the DR requirement situation.

The system management apparatus according to the first embodiment of the invention can derive the cloud DR configuration (a cloud DR configuration including a cloud DR configuration at a low cost) satisfying the DR requirements (RTO/RPO/RLO). Further, the system management apparatus according to the first embodiment of the invention can stimulate and recommend adoption of the cloud DR configuration at a low cost to the user by presenting the cost of the cloud DR configuration from which the cost is derived.

### Second Embodiment

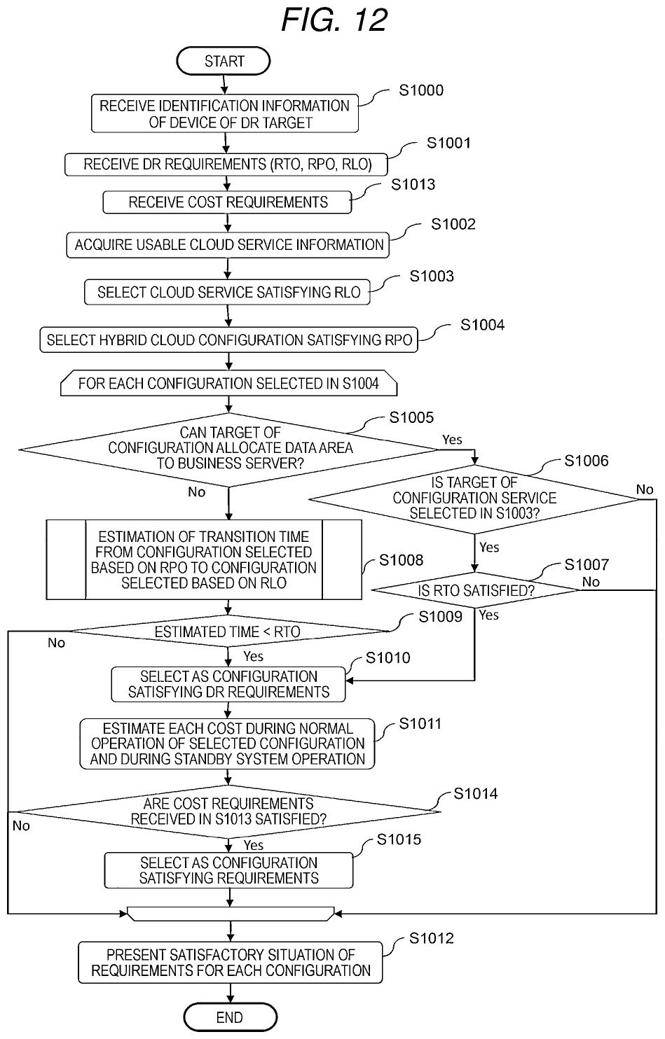

A system management apparatus according to a second embodiment of the invention will be described. The system management apparatus according to the second embodiment of the invention is different from the system management apparatus according to the first embodiment of the invention in that a procedure example of the cloud DR configuration derivation process of FIG. 12 is executed instead of the procedure example of the cloud DR configuration derivation process illustrated in the flowchart of FIG. 8.

A flowchart illustrated in FIG. 12 is different from the flowchart illustrated in FIG. 8 in only the following points.
Step S1013 is added between steps S1001 and S1002.
Steps S1014 and S1015 are added between steps S1011 and S1012.

Hereinafter, these differences will be mainly described and the other steps are already described, and description thereof will be omitted.

In step S1013, the configuration derivation program 111 receives a cost requirement. For example, the configuration derivation n program 111 receives a cost requirement input by a user through a GUI screen (not illustrated). For example, the management server 101 is considered to have a configuration in cooperation with another cost management system (not illustrated). The configuration derivation program 111 may receive the cost requirement from the cost management system.

In step S1014, the configuration derivation program 111 determines whether a cost at the normal operation time of the selected configuration estimated in step S1011 and a cost at the standby system operation time satisfy the cost requirement received in step S1013. The cost requirement is less than a predetermined cost set as a threshold (threshold cost). When a calculated cost is less than the threshold cost, it is determined that the cost requirement is satisfied. When the calculated cost is the threshold cost or more, it is determined that the cost requirement is not satisfied.

When the cost at the normal operation time and the cost at the standby operation time of the selected configuration estimated in step S1011 do not satisfy the cost requirement received in step S1013, the configuration derivation program 111 determines “No” in step S1014 and moves to a process of a subsequent configuration.

When the cost at the normal operation time and the cost at the standby operation time of the selected configuration estimated in step S1011 satisfy the cost requirement received in step S1013, the configuration derivation program 111 determines “Yes” in step S1014, moves to step S1015, selects this configuration as a configuration satisfying the DR requirements and the cost requirement, and moves to a process of a subsequent configuration.

The cost may be compared with the cost requirement by using only the cost at the normal operation time or may be compared with the cost requirement by additionally adding the cost at the standby system operation time. For example, when the operating rate of a storage of a DR source is 99.9%, “cost per unit time at normal operation time”×“999/1000”+“cost per unit time at standby system operation time”×“1/1000” or the like may be used.

### Advantages

As described above, the system management apparatus according to the second embodiment of the invention can derive an appropriate configuration in a cloud DR based on the DR requirements (RTO/RPO/RLO) and the cost requirement (cost). In JP4598817B exemplified in “Description of Related Art”, only a DR configuration using a specific function, specifically, asynchronous storage replication, is taken into consideration and an appropriate (proper) DR configuration based on the DR requirements (RTO/RPO/RLO) and the cost cannot be determined among diverse configurations that can be taken in the cloud DRs.

### Modifications

The invention is not limited to the foregoing embodiments and includes various modifications and equivalent configurations within the gist of the appended claims. For example, the foregoing embodiments have been described in detail to further understand the invention and all the described configurations are not necessarily included. Some of the configurations according to a certain embodiment may be replaced with a configuration according to another embodiment. A configuration according to another embodiment may be added to a configuration according to a certain embodiment. Other configurations of each embodiment may be added to, deleted from, or replaced with some of the configurations according to each embodiment.

Some or all of the foregoing configurations, functions, processing units, processing mechanisms, and the like may be implemented with hardware by designing, for example, integrated circuits or may be implemented with software by causing processors to interpret and d execute programs implementing the functions.

Information regarding a program, a table, a file, or the like implementing each function can be stored in a storage device such as a memory, a hard disk drive, or a solid state drive (SSD), or a recording medium such as an integrated circuit (IC) card, an SD card, or a digital versatile disc (DVD).

Control lines and information lines indicate lines considered to be required for description, and cannot be said to be all control lines and information lines required for implementation. Actually, it may be considered that almost all the configurations are connected to each other.

What is claimed is:

1. A system management apparatus comprising:
an information processing device configured to manage a system including a storage of a specific data center and a storage by a cloud service provided from another data center other than the specific data center, wherein
the information processing device is configured to request, from the system, a disaster recovery configuration using the storage by the cloud service satisfying a recovery time objective requirement, a recovery point objective requirement, and a recovery level objective requirement, based on the recovery time objective requirement related to a recovery time objective, the recovery point objective requirement related to a recovery point objective, and the recovery level objective requirement related to a recovery level objective.

2. The system management apparatus according to claim 1, wherein the information processing device is configured to make a request for the disaster recovery configuration further satisfying a cost requirement, based on the cost requirement related to a cost in addition to the recovery time objective requirement, the recovery point objective requirement, and the recovery level objective requirement.

3. The system management apparatus according to claim 1, wherein the information processing device is configured to estimate a transition time when transitioning from the storage by the cloud service used for a normal operation of the disaster recovery configuration to the storage by the cloud service used for a standby system operation, and to determine whether to satisfy the recovery time objective requirement using the estimated transition time.

4. The system management apparatus according to claim 1, wherein the information processing device is configured to calculate a cost related to the requested disaster recovery configuration.

5. The system management apparatus according to claim 1, wherein the information processing device is configured to make a request for a cloud configuration that is a configuration related to the storage by the cloud service used for a disaster recovery and a copy configuration that is a configuration related to a data copy for the disaster recovery, as the disaster recovery configuration.

6. The system management apparatus according to claim 5, wherein
the information processing device is configured to
make a request for the cloud service used for the disaster recovery, a start location of the cloud service used for the disaster recovery, and a configuration and performance of the storage by the cloud service, as the cloud configuration, and
make a request for a copy function for the disaster recovery, a copy parallel number, and an inter-site NW bandwidth between a source site and a target site of the disaster recovery configuration, as the copy configuration.

7. The system management apparatus according to claim 6, wherein the information processing device is configured to make a request for the disaster recovery configuration satisfying the recovery time objective requirement, the recovery point objective requirement, and the recovery level objective requirement, by selecting the usable cloud service, selecting the cloud configuration satisfying the recovery level objective requirement from the selected cloud service, selecting a hybrid cloud configuration of the source and the target satisfying the recovery point objective requirement from the selected cloud configuration, and selecting the cloud configuration for a normal operation of the target satisfying the recovery time objective requirement and the cloud configuration for a standby system operation from the cloud configuration satisfying the selected recovery level objective requirement and the hybrid cloud configuration satisfying the selected recovery point objective requirement.

8. The system management apparatus according to claim 4, further comprising:
a display device configured to display an image, wherein
the information processing device is configured to display an image indicating information regarding the disaster recovery configuration and an image indicating a cost related to the disaster recovery configuration, on the display device.

9. The system management apparatus according to claim 1, wherein the information processing device is configured to set the recovery time objective requirement, the recovery point objective requirement, and the recovery level objective requirement, based on information input via an input device by a user.

10. The system management apparatus according to claim 1, wherein the information processing device is configured to notify an external device of an alert when the requested disaster recovery configuration does not satisfy the recovery time objective requirement, the recovery point objective requirement, and the recovery level objective requirement with a change in a situation.

11. The system management apparatus according to claim 1, wherein the information processing device is configured to make a request for another disaster recovery configuration when the requested disaster recovery configuration does not satisfy the recovery time objective requirement, the recovery point objective requirement, and the recovery level objective requirement with a change in a situation.

12. The system management apparatus according to claim 11, wherein the information processing device is configured to inspect whether the change in the situation is at least one of a change in a data capacity of a target of the disaster recovery, occurrence of a failure in a cloud service and occurrence a failure in an NW related to the disaster recovery configuration, and a change in a cloud service specification related to the disaster recovery configuration.

13. A system management method using an information processing device configured to manage a system including a storage of a specific data center and a storage by a cloud service provided from another data center other than the specific data center, the method comprising:
causing the information processing device to request, from the system, a disaster recovery configuration using the storage by the cloud service satisfying a recovery time objective requirement, a recovery point objective requirement, and a recovery level objective requirement, based on the recovery time objective requirement related to a recovery time objective, the recovery point objective requirement related to a recovery point objective, and the recovery level objective requirement related to a recovery level objective.

14. A system management program causing a computer to execute a process for managing a system including a storage of a specific data center and a storage by a cloud service provided from another data center other than the specific data center, the process of:
requesting, from the system, a disaster recovery configuration using the storage by the cloud service satisfying a recovery time objective requirement, a recovery point objective requirement, and a recovery level objective requirement, based on the recovery time objective requirement related to a recovery time objective, the recovery point objective requirement related to a recovery point objective, and the recovery level objective requirement related to a recovery level objective.
